(19) United States
(12) Patent Application Publication
(10) Pub. No.: US 2025/0011596 A1
(43) Pub. Date: Jan. 9, 2025

(54) SILICONE CORE ACRYLIC SHELL IMPACT MODIFIERS CONTAINING PHOSPHORUS

(71) Applicant: Rohm and Haas Company, Collegeville, PA (US)

(72) Inventors: Pu Luo, King Of Prussia, PA (US); Morris Wills, Philadelphia, PA (US)

(21) Appl. No.: 18/712,540

(22) PCT Filed: Dec. 7, 2022
(86) PCT No.: PCT/US2022/052069

§ 371 Date: May 22, 2024

Related U.S. Application Data
(63) Continuation of application No. 63/287,550, filed on Dec. 9, 2021.

(51) Int. Cl. C08L 83/08

(52) U.S. Cl. CPC C08L 83/08; C08L 2207/53

(57) ABSTRACT

Provided are multistage polymer compositions comprising (a) a core comprising a silicone polymer, and (b) a shell comprising a silicone polymer. At least one of the silicone polymer in the core and the acrylic polymer in the shell comprise polymerized units derived from an organo-phosphorus monomer. Also provided are matrix resin compositions comprising such polymer compositions and a matrix resin.

### FIELD OF THE INVENTION

This invention relates generally to multistage polymer compositions containing phosphorus that are useful as impact modifiers. More specifically, the compositions relate to multistage polymer compositions with silicone cores and acrylic shells in the multistage polymer.

### BACKGROUND

In the manufacture of products, there is the general desire to achieve ease of manufacture as well as lightweighting, i.e., reducing the weight of a product. Both of these objectives are achieved through the use of plastic, relative to the use of metal or ceramic. On the other hand, it is generally desirable for manufactured items to have low to no flammability which is provided by the use of metal or ceramic, but is generally not provided by the use of plastic.

Recently, plastic formulations have been developed with improved (i.e., lower) levels of flammability. In general, these formulations contain high levels of flame retardant additives in addition to anti-drip additives. These formulations have been able to achieve certain criteria as designated by UL (Underwriter Laboratories) that enable their use in the manufacture of electrical items as well as items for use under the hood of a car.

These plastic formulations generally have the requirement in use of substantial impact strength. However, the additives used to achieve lower flammability typically decrease the impact strength of the molded product. It is very common to add a core shell polymer impact modifier to these formulations to reach the required level of impact strength. However, the polymers used to make these core shell impact modifiers can be highly flammable and increase the flammability of the formulation in direct correlation to the amount utilized in the formulation. Thus, there exists a problem in the area of plastics formulation-achieving the proper balance of impact strength and flammability.

U.S. Pat. No. 5,219,907 discloses the use of a core shell emulsion polymer that contains a phosphate monomer as part of the shell, where the core shell polymer can be used in a polycarbonate formulation. The core comprises an elastomer selected from polybutadiene or a crosslinked polyacrylate rubber.

EP 0 663 410 discloses the use of a high concentration of phosphorus monomer located in a graft polymer on a rubbery substrate to provide improved flammability. The rubbery substrate is an alkyl acrylate rubber or an olefinic rubber.

There is a need to develop new processes and impact modifier polymer compositions comprising a silicone core that have improved flammability.

### SUMMARY OF THE INVENTION

One aspect of the invention provides a multistage polymer composition comprising: (a) a core comprising a silicone polymer; and (b) a shell comprising an acrylic polymer. At least one of the silicone polymer in the core and the acrylic polymer in the shell comprise polymerized units derived from an organo-phosphorus monomer.

In another aspect, the invention provides a matrix resin composition comprising: (A) a multistage polymer composition comprising (i) a core comprising a silicone polymer, and (ii) a shell comprising an acrylic polymer, and (B) one or more matrix resins. At least one of the silicone polymer in the core and the acrylic polymer in the shell comprise a polymerized units derived from an organo-phosphorus monomer.

### BRIEF DESCRIPTION OF THE DRAWINGS

FIG. 1 is a graph of the burn times for resin compositions according to embodiments of the invention.

### DETAILED DESCRIPTION

The inventors have surprisingly found that an organo-phosphorus monomer can be incorporated into a silicone core/acrylic shell multistage polymer and increase the flammability resistance of the multistage polymer.

As used herein, the term “polymer” refers to a polymeric compound prepared by polymerizing monomers, whether of the same or a different type. The generic term “polymer” includes the terms “homopolymer,” “copolymer,” “terpolymer,” and “resin.” As used herein, the term “polymerized units derived from” refers to polymer molecules that are synthesized according to polymerization techniques wherein a product polymer contains “polymerized units derived from” the constituent monomers which are the starting materials for the polymerization reactions. As used herein, the term “(meth)acrylate” refers to either acrylate or methacrylate or combinations thereof, and the term “(meth)acrylic” refers to either acrylic or methacrylic or combinations thereof. As used herein, the term “substituted” refers to having at least one attached chemical group, for example, alkyl group, alkenyl group, vinyl group, hydroxyl group, carboxylic acid group, other functional groups, and combinations thereof.

As used herein, the term “organo-phosphorus” refers to organic compounds containing phosphorus. As used herein, the term “phosphate” refers to an anion that is made up of phosphorus and oxygen atoms, where the phosphorus is in the +5 oxidation state. Included are orthophosphate (PO₄⁻³), the polyphosphates (PₙO₃ₙ₊₁⁻⁽ⁿ⁺²⁾ where n is 2 or larger), and the metaphosphates (circular anions with the formula PₘO₃ₘ^{-m} where m is 2 or larger). As used herein, an “alkaline phosphate” refers to a salt of an alkali metal cation with a phosphate anion. Alkaline phosphates include alkali metal orthophosphates, alkali metal polyphosphates, and alkali metal metaphosphates. Alkaline phosphates also include partially neutralized salts of phosphate acids, including, for example, partially neutralized salts of orthophosphoric acid such as, for example, monosodium dihydrogen phosphate and disodium hydrogen phosphate. As used herein, the term “phosphonate” refers to an anion that is that is made up of phosphorus and oxygen atoms, where the phosphorus is in the +3 oxidation state.

As used herein, the term “multistage polymer” refers to a polymer that is made by forming (i.e., polymerizing) a first polymer, called the “first stage” or the “first stage polymer,” which forms the core of the multistage polymer. Then, in the presence of the first stage, forming a second polymer called the “second stage” or “second stage polymer, which can be an intermediate stage or the final stage of the multistage polymer. The multistage polymer may comprise additional stages, which may be formed before or after the second stage polymer. Each intermediate stage is formed in the presence of the polymer resulting from the polymerization of the stage immediately previous to that intermediate stage. In such embodiments wherein each subsequent stage forms a partial or complete shell around each of the particles remaining from the previous stage, the multistage polymer that results is known as a “core/shell” polymer, where the first stage polymer comprises the core and each subsequent stage comprises a shell on the preceding stage with the final stage forming the outermost shell. Thus, the second stage polymer will comprise at least part of the shell in the multistage polymer.

As used herein, the term “weight average molecular weight” or “Mw” refers to the weight average molecular weight of a polymer as measured by gel permeation chromatography (“GPC”), for acrylic polymers against polystyrene calibration standards following ASTM D5296-11 (2011), and using tetrahydrofuran (“THF”) as the mobile phase and diluent. As used herein, the term “weight of polymer” means the dry weight of the polymer.

As used herein, the terms “glass transition temperature” or “T_{g}” refers to the temperature at or above which a glassy polymer will undergo segmental motion of the polymer chain. Glass transition temperatures of a copolymer can be estimated by the Fox equation (Bulletin of the American Physical Society, 1 (3) Page 123 (1956)) as follows:

$$1 / {T}_{g} = {w}_{1} / {T}_{g ( 1 )} + {w}_{2} / {T}_{g ( 2 )}$$

For a copolymer, w₁ and w₂ refer to the weight fraction of the two comonomers, and T_{g(1)} and T_{g(2)} refer to the glass transition temperatures of the two corresponding homopolymers made from the monomers. For polymers containing three or more monomers, additional terms are added (wₙ/T_{g(n)}). The glass transition temperatures of the homopolymers may be found, for example, in the “Polymer Handbook,” edited by J. Brandrup and E. H. Immergut, Interscience Publishers. The T_{g} of a polymer can also be measured by various techniques, including, for example, differential scanning calorimetry (“DSC”). As used herein, the phrase “calculated T_{g}” shall mean the glass transition temperature as calculated by the Fox equation. When the T_{g} of a multistage polymer is measured, more than one T_{g} may be observed. The T_{g} observed for one stage of a multistage polymer may be the same as the T_{g} that is characteristic of the polymer that forms that stage (i.e., the T_{g} that would be observed if the polymer that forms that stage were formed and measured in isolation from the other stages). When a monomer is said to have a certain T_{g}, it is meant that a homopolymer made from that monomer has that T_{g}.

A compound is considered “water-soluble” herein if the amount of that compound that can be dissolved in water at 20° C. is 5 g or more of compound per 100 ml of water. A compound is considered “water-insoluble” herein if the amount of that compound that can be dissolved in water at 20° C. is 0.5 g or less of compound per 100 ml of water. If the amount of a compound that can be dissolved in water at 20° C. is between 0.5 g and 5 g per 100 ml of water, that compound is said herein to be “partially water-soluble.”

As used herein, when it is stated that “the polymer composition contains little or no” of a certain substance, it is meant that the polymer composition contains none of that substance, or, if any of that substance is present in the present composition, the amount of that substance is 1% or less by weight, based on the weight of the polymer composition. Among embodiments that are described herein as having “little or no” of a certain substance, embodiments are envisioned in which there is none of that certain substance.

The multistage polymer of the present invention comprises a core and a shell. The core comprises a silicone polymer, and the shell comprises an acrylic polymer. One or both of the silicone polymer and the acrylic polymer contain polymerized units derived from an organo-phosphorus monomer.

The silicone (i.e., polysiloxane) polymer can be synthesized by any of chain organosiloxanes and cyclic organosiloxanes. In particular, cyclic organosiloxanes are preferred. Among them, cyclic organosiloxanes having from 3- to 7-membered rings are preferable. Specific examples thereof include, but are not limited to, hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, and octaphenylcyclotetrasiloxane. These may be used singly or two or more kinds thereof may be used concurrently. Among them, it is preferable to use octamethylcyclotetrasiloxane as the monomer.

The silicone polymer preferably contains a siloxane crosslinking agent for better elasticity and impact strength. The siloxane-based crosslinking agent is preferably selected from those which have a siloxy group. The use of the siloxane-based crosslinking agent makes it possible to obtain a polyorganosiloxane having a crosslinked structure. Specific examples of the siloxane-based crosslinking agent include a trifunctional or tetrafunctional silane-based crosslinking agent such as trimethoxymethylsilane, triethoxyphenylsilane, tetramethoxysilane, tetraethoxysilane, tetra-n-propoxysilane and tetrabutoxysilane. Among them, a tetrafunctional crosslinking agent is preferable and tetraethoxysilane is more preferable.

The silicone polymer may also contains polymerized units of one or more graftlinkers. A graftlinker is a monomer that can bond with both the (meth)acrylic polymers and the silicone polymer, through reaction with (meth)acrylates and siloxanes. Preferred graftlinkers include siloxane compounds having a polymerizable vinyl functional group and are capable of combining with dimethylsiloxane through a siloxane bond.

Examples of siloxanes having a polymerizable vinyl functional group include, but are not limited to, (meth)acryloyloxysilanes such as β-(meth)acryloyloxyethyldimethoxymethylsilane, γ-(meth)acryloyloxypropyldimethoxymethylsilane, γ-(meth)acryloyloxypropylmethoxydimethylsilane, γ-(meth)acryloyloxypropyltrimethoxysilane, γ-(meth)acryloyloxypropylethoxydiethylsilane, γ-(meth)acryloyloxypropyldiethoxymethylsilane, and δ-(meth)acryloyloxybutyldiethoxymethylsilane; vinylsiloxanes such as tetramethyltetravinylcyclotetrasiloxane and methoxydimethylvinylsilane; vinylphenylsilanes such as p-vinylphenyldimethoxymethylsilane; mercaptosiloxanes such as γ-mercaptopropyldimethoxymethylsilane and γ-mercaptopropyltrimethoxysilane; and disiloxanes such as 1,3-bis(3-methacryloyloxypropyl)tetramethyldisiloxane and 1,3-bis(3-mercaptopropyl)tetramethyldisiloxane.

In the multistage polymer, one or both of the silicone polymer in the core and the acrylic polymer in the shell comprise polymerized units derived from an organo-phosphorus monomer. Thus, the multistage polymer may comprise a phosphorus-containing silicone polymer in the core and an acrylic polymer in the shell, a silicone polymer in the core and a phosphorus-containing acrylic polymer in the shell, or a phosphorus-containing silicone polymer in the shell and a phosphorus-containing acrylic polymer in the shell.

When the silicone polymer comprises polymerized units derived from an organo-phosphorus monomer, the organo-phosphorus monomer may be selected from phospho-silane monomers. The phospho-silane monomer may be selected from compounds of formula Si(OR²)₃—R³—P(O)(OR⁴)₂. R² and R⁴ may be independently selected from hydrogen and C₁ to C₁₂ alkyl groups. R³ may be selected from C₁ to C₁₂ alkyl groups. Preferably, R², R³, and R⁴ are independently selected from C₁ to C₆ alkyl groups.

When the silicone polymer in the core comprises polymerized units derived from a phospho-silane monomer, the phospho-silane monomer may be present in an amount ranging from 0.1 to 20 wt % relative to the total weight of the silicone polymer. For example, the phospho-silane monomer may be present in an amount of at least 0.25 wt %, at least 0.5 wt %, or at least 1 wt % based on the total weight of the silicone polymer. The phospho-silane monomer may be present, for example, in an amount of no more than 15 wt %, no more than 10 wt %, or no more than 5 wt % based on the total weight of the silicone polymer.

The multistage polymer may contain the silicone polymer, for example, in an amount of 2 wt % or more, 5 wt % or more, 10 wt % or more, or 20 wt % or more, or 50 wt % or more, based on the total weight of the multistage polymer. The multistage polymer may contain the silicone polymer in an amount of 98 wt % or less, or 95 wt % or less, or 90 wt % or less, based on the total weight of the multistage polymer.

The multistage polymer of the present invention contains an acrylic polymer in the shell. The acrylic polymer may comprise polymerized units derived from one or more monomers selected from substituted and unsubstituted alkyl (meth)acrylate monomers.

Suitable alkyl groups in the at least one alkyl (meth)acrylate monomers include straight or branched C₁ to C₁₂ alkyl groups. Preferred alkyl groups include methyl, ethyl, propyl, butyl, hexyl, 2-ethylhexyl, and octyl groups. Preferably, the alkyl (meth)acrylate monomers comprise methyl methacrylate.

The acrylic polymer may further comprise polymerized units derived from other monomers, such as, for example, styrene monomers.

When the acrylic polymer in the shell comprises polymerized units derived from organo-phosphorus monomers. Examples of organo-phosphorus monomers include:

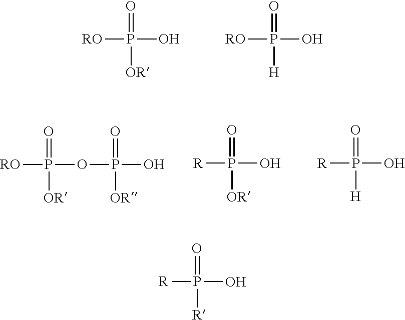

where R is an organic group containing an acryloxy, methacryloxy, or a vinyl group, and R′ and R″ are independently selected from H and a second organic group. The second organic group may be saturated or unsaturated. Suitable organo-phosphorus monomers include dihydrogen phosphate-functional monomers such as dihydrogen phosphate esters of an alcohol in which the alcohol also contains a polymerizable vinyl or olefinic group, such as allyl phosphate, mono- or diphosphate of bis(hydroxy-methyl) fumarate or itaconate, derivatives of (meth)acrylic acid esters, such as, for examples phosphates of hydroxyalkyl (meth)acrylates including 2-hydroxyethyl (meth)acrylate, 3-hydroxypropyl (meth)acrylates, and the like.

Other suitable organo-phosphorous monomers include CH₂═C(R⁵)C(O)—O—(R⁶O)ₙ—P(O)(OH)₂, where R⁵ is H or —CH₃, R⁶=alkyl, and n=1 to 5, such as the methacrylates SIPOMER™ PAM-100, SIPOMER™ PAM-200, SIPOMER™ PAM-400, SIPOMER™ PAM-600 and the acrylate, SIPOMER™ PAM-300, available from Solvay.

Other suitable organo-phosphorus monomers are phosphonate functional monomers, disclosed in WO 99/25780 A1, and include vinyl phosphonic acid, allyl phosphonic acid, 2-acrylamido-2-methylpropanephosphonic acid, α-phosphonostyrene, 2-methylacrylamido-2-methylpropanephosphonic acid. Further suitable organo-phosphorus monomers are 1,2-ethylenically unsaturated (hydroxy)phosphinylalkyl(meth)acrylate monomers, disclosed in U.S. Pat. No. 4,733,005, and include (hydroxy)phosphinylmethyl methacrylate.

Preferably, the organo-phosphorus monomers comprise at least one compound of formula CH₂═C(R⁵)—C(O)—O—(R⁶O)ₙ—P(O)(OH)₂. More preferably, R⁵ is —CH₃, R⁶ is an alkyl group comprising 1 to 6 carbon atoms, and n=1.

The acrylic polymer in the shell may contain polymerized units derived from the at least one organo-phosphorus monomer in an amount of 0.25 weight % or more, or 0.5 weight % or more, based on the total weight of the acrylic polymer. The second stage polymer may contain polymerized units derived from the at least one organo-phosphorus monomer in an amount of 20 weight % or less, 15 weight % or less, or 10 weight % or less, based on the total weight of the acrylic polymer. Preferably, the acrylic polymer contains polymerized units derived from the at least one organo-phosphorus monomer in an amount ranging from 0.5 to 20 weight % based on total weight of the acrylic polymer. More preferably, the acrylic polymer contains polymerized units derived from the at least one organo-phosphorus monomer in an amount ranging from 2 to 10 weight % based on the total weight of the acrylic polymer.

The acrylic polymer may further comprise additional components. For example, the acrylic polymer may comprise one or more of a crosslinker, a chain transfer agent, or a functional monomer.

The acrylic polymer may have a T_{g} of 50° C. or more, or 90° C. or more. The final stage polymer may have a T_{g} of 200° C. or less, or 150° C. or less.

The multistage polymer may contain the acrylic polymer, for example, in an amount of 2 weight % or more, or 10 weight % or more, or 20 weight % or more, based on the total weight of the multistage polymer. The multistage polymer may contain the acrylic polymer, for example, in an amount of 98 weight % or less, 80 weight % or less, 70 weight % or less, or 60 wt % or less, based on the total weight of the multistage polymer.

Preferably, the acrylic polymer contains polymerized units derived from monomers having a T_{g} of 50° C. or higher in an amount of 50 wt % or higher, or 75 wt % or higher, or 90 wt % or higher based on the total weight of the acrylic polymer.

The multistage polymer may contain one or more intermediate stage polymers in the shell in addition to the acrylic polymer. The total sum of the intermediate stage polymers may be present in an amount of 1 weight % or more, or 2 weight % or more, or 5 weight % or more, or 10 weight % or more, based on the total weight of the multistage polymer. The total sum of the intermediate stage polymers may be present in an amount of 60 weight % or less, or 2 weight % or less, or 5 weight % or less, or 10 weight % or less, based on the total weight of the multistage polymer. Like the acrylic polymer in shell of the multistage polymer, the one or more intermediate stage polymers may also comprise polymerized units derived from one or more organo-phosphorus monomers.

The multistage polymer may be made using any conventional methods. For example, the silicone polymer may be made by acid catalyzed aqueous emulsion polymerization. The acrylic polymer may be made by radical aqueous emulsion polymerization. In aqueous emulsion polymerization, water forms the continuous medium in which polymerization takes place. The water may or may not be mixed with one or more additional compounds that are miscible with water or that are dissolved in the water. The continuous medium may contain 30 weight % or more water, or 50 weight % or more water, or 75 weight % or more water, or 90 weight % or more water, based on the weight of the continuous medium. Emulsion polymerization of the siloxane monomers is catalyzed by acid. Examples of the acid catalyst to be used for polymerization of the siloxane mixture include, but are not limited to, sulfonic acids such as aliphatic sulfonic acid, aliphatic substituted benzene sulfonic acid, and aliphatic substituted naphthalene sulfonic acid; and mineral acids such as sulfuric acid, hydrochloric acid, and nitric acid. These acids can be used alone or in a combination of two or more kinds thereof.

Emulsion polymerization of the (meth)acrylic polymer involves the presence of one or more initiator. An initiator is a compound that forms one or more free radical, which can initiate a polymerization process. The initiator is usually water-soluble. Some suitable initiators form one or more free radical when heated. Some suitable initiators are oxidants and form one or more free radical when mixed with one or more reductant, or when heated, or a combination thereof. Some suitable initiators form one or more free radical when exposed to radiation such as, for example, ultraviolet radiation or electron beam radiation. A combination of suitable initiators is also suitable.

Preferably, the multistage polymer produced in the form of a latex. As used herein, the term “latex” refers to the physical form of a polymer in which the polymer is present in the form of small polymer particles that are dispersed in water. The latex may have, for example, a mean particle size of 50 nm or greater or 100 nm or greater. The latex may have a mean particle size of 1,000 nm or less, or 800 nm or less, or 600 nm or less.

The emulsion polymerization may involve the use of at least one organo-phosphorus soap comprising an anionic phosphate surfactant. Each anionic phosphate surfactant has a cation associated with it forming an alkaline metal salt of the phosphate surfactant including, for example, alkyl phosphate salts and alkyl aryl phosphate salts. Suitable cations include, for example, ammonium, cation of an alkali metal, and mixtures thereof. Suitable alkaline metal salts of the phosphate surfactant include, for example, polyoxyalkylene alkyl phenyl ether phosphate salt, polyoxyalkylene alkyl ether phosphate salt, polyoxyethylene alkyl phenyl ether phosphate salt, and polyoxyethylene alkyl ether phosphate salt. The alkaline metal salt of the phosphate surfactant may comprise a polyoxyethylene alkyl ether phosphate salt. The weight of the phosphate surfactant present in emulsion polymerization of the multistage polymer may range from, for example, 0.5 wt % or more, preferably 1.0 wt % or more, and more preferably 1.5 wt % or more, as characterized by weight of phosphate surfactant based on the total monomer weight added to the polymerization. The weight of the phosphate surfactant present in emulsion polymerization of the multistage polymer may range from, for example, 5 wt % or less, preferably 4 wt % or less, and more preferably 3 wt % or less, as characterized by weight of phosphate surfactant based on the total monomer weight added to the polymerization. One or more anionic surfactants in addition to the anionic phosphate surfactant described above may be utilized in the emulsion polymerization. Suitable additional anionic surfactants include, for example, carboxylates, sulfosuccinates, sulfonates, and sulfates.

In the process of the present invention, the multistage polymer latex can isolated by coagulation or spray drying to retain the organo-phosphorus soap on the surface of the multistage polymer. Suitable methods of coagulation include, for example, coagulation with a divalent cation.

Suitable divalent cations include, for example, divalent metal cations and alkaline earth cations. Suitable divalent cations include, for example, calcium (+2), cobalt (+2), copper (+2), iron (+2), magnesium (+2), zinc (+2), and mixtures thereof. Preferably, the multivalent cations are selected from calcium (+2), and magnesium (+2). More preferably, every divalent cation that is present is calcium (+2), or magnesium (+2), or a mixture thereof. Even more preferably, the divalent cation comprises calcium (+2). The divalent cation may be present, for example, in an amount of 10 ppm or more, or 30 ppm or more, or 100 ppm or more, by weight based on the dry weight of multistage polymer. The divalent cation may be present, for example, in an amount of 3 weight % or less, or 1 weight % or less, or 0.3 weight % or less, based on the dry weight of the multistage polymer.

Preferably, most or all of the divalent cation that is present in the composition is in the form of a water insoluble phosphate salt. The molar amount of divalent cation that is present in the form of a water insoluble phosphate salt may be, for example, 80% or more, or 90% or more, or 95% or more, or 98% or more, or 100%, based on the total moles of divalent cation present in the composition.

Preferably, most or all of the water that remains with the isolated polymer is removed from the isolated polymer by one or more of the following operations: filtration (including, for example, vacuum filtration), and/or centrifugation. The isolated polymer maybe optionally washed with water one or more times. Coagulated polymer is a complex structure, and it is known that water cannot readily contact every portion of the coagulated polymer. While not wishing to be bound by theory, it is contemplated that a significant amount of divalent cation and residual organo-phosphorus soap will be left behind. Accordingly, the composition of the present invention may contain organo-phosphorus soap in an amount of 50 ppm or more, or 100 ppm or more, or 500 ppm or more, based on the dry weight of the multistage polymer. The composition of the present invention may contain organo-phosphorus soap in an amount of 10,000 ppm or less, or 7,500 ppm or less, or 5,000 ppm or less, based on the dry weight of the multistage polymer.

Preferably, the dried multistage polymer has a water content of less than 1.0 weight % based on the weight of the dried multistage polymer.

The polymer composition of the present invention may also include a flow aid. A flow aid is a hard material in the form of a powder (mean particle diameter of 1 micrometer to 1 mm). Suitable flow aids include, for example, hard polymers (i.e., polymers having a T_{g} of 80° C. or higher) or a mineral (e.g., silica).

The polymer composition of the present invention may also include a stabilizer. Suitable stabilizers include, for example, radical scavengers, peroxide decomposers, and metal deactivators. Suitable radical scavengers include, for example, hindered phenols (e.g., those having a tertiary butyl group attached to each carbon atom of the aromatic ring that is adjacent to the carbon atom to which a hydroxyl group is attached), secondary aromatic amines, hindered amines, hydroxylamines, and benzofuranones. Suitable peroxide decomposers include, for example, organic sulfides (e.g., divalent sulfur compounds, e.g., esters of thiodipropionic acid), esters of phosphorous acid (H₃PO₃), and hydroxyl amines. Suitable metal deactivators include, for example, chelating agents (e.g., ethylenediaminetetraacetic acid).

In the process of the present invention, the multistage polymer latex can isolated by coagulation or spray drying. Suitable methods of coagulation include, for example, coagulation with a divalent cation.

Preferably, most or all of the water that remains with the isolated polymer is removed from the isolated polymer by one or more of the following operations: filtration (including, for example, vacuum filtration), and/or centrifugation. The isolated polymer maybe optionally washed with water one or more times.

Preferably, the dried multistage polymer has a water content of less than 1.0 weight % based on the weight of the dried multistage polymer.

The polymer composition of the present invention may also include a flow aid. A flow aid is a hard material in the form of a powder (mean particle diameter of 1 micrometer to 1 mm). Suitable flow aids include, for example, hard polymers (i.e., polymers having a T_{g} of 80° C. or higher) or a mineral (e.g., silica).

The polymer composition of the present invention may also include a stabilizer. Suitable stabilizers include, for example, radical scavengers, peroxide decomposers, and metal deactivators. Suitable radical scavengers include, for example, hindered phenols (e.g., those having a tertiary butyl group attached to each carbon atom of the aromatic ring that is adjacent to the carbon atom to which a hydroxyl group is attached), secondary aromatic amines, hindered amines, hydroxylamines, and benzofuranones. Suitable peroxide decomposers include, for example, organic sulfides (e.g., divalent sulfur compounds, e.g., esters of thiodipropionic acid), esters of phosphorous acid (H₃PO₃), and hydroxyl amines. Suitable metal deactivators include, for example, chelating agents (e.g., ethylenediaminetetraacetic acid).

As noted above, one aspect of the present invention utilizes the polymer composition described herein as an impact modifier in a matrix resin composition containing the multistage polymer composition and a matrix resin. After the mixture of multistage polymer and matrix resin is mixed and melted and formed into a solid item, the impact resistance of that item will be better than the same solid item made with matrix resin that has not been mixed with multistage polymer. The multistage polymer may be provided in a solid form, e.g., pellets or powder or a mixture thereof. The matrix resin may also be provided in solid form, e.g., pellets or powder or a mixture thereof. Solid multistage polymer may be mixed with solid matrix resin, either at room temperature (20° C.) or at elevated temperature (e.g., 30° C. to 90° C.). Alternatively, solid multistage polymer may be mixed with melted matrix resin, e.g., in an extruder or other melt mixer. Solid multistage polymer may also be mixed with solid matrix resin, and the mixture of solids may then heated sufficiently to melt the matrix resin, and the mixture may be further mixed, e.g., in an extruder or other melt-processing device.

The weight ratio of the matrix resin to the multistage polymer of the present invention may range for example, from 1:1 or higher, or 1.1:1 or higher, or 2.3:1 or higher, or 4:1 or higher, or 9:1 or higher, or 19:1 or higher, or 49:1 or higher, or 99:1 or higher.

Suitable matrix resins include, for example, polyolefins, polystyrene, styrene copolymers, poly(vinyl chloride), poly(vinyl acetate), acrylic polymers, polyethers, polyesters, polycarbonates, polyurethanes, and polyamides. Preferably, the matrix resin contains at least one polycarbonate. Suitable polycarbonates include, for example homopolymers of polymerized units derived from Bisphenol A (“BPA”), and also copolymers that include polymerized units of BPA along with one or more other polymerized units.

The matrix resin may contain at least one polyester. Suitable polyesters include, for example, polyethylene terephthalate and polybutylene terephthalate.

The matrix resin may contain a blend of polymers. Suitable blends of polymers include, for example, blends of polycarbonates and styrene resins, and blends of polycarbonates and polyesters. Suitable styrene resins include, for example, polystyrene and copolymers of styrene with other monomers, e.g., acrylonitrile/butadiene/styrene (“ABS”) resins.

The matrix resin composition containing multistage polymer and matrix resin may contain one or more additional materials that are added to the mixture. Any one or more of such additional materials may be added to the multistage polymer or to the matrix resin prior to formation of the final mixture of all materials. Each of the additional materials (if any are used) may be added (alone or in combination with each other and/or in combination with multistage polymer) to matrix resin when matrix resin is in solid form or in melt form. Suitable additional materials include, for example, dyes, colorants, pigments, carbon black, fillers, fibers, lubricants (e.g., montan wax), flame retardants (e.g., borates, antimony trioxide, or molybdates), and other impact modifiers that are not multistage polymers of the present invention.

The matrix resin composition may be used to form a useful article, for example by film blowing, profile extrusion, molding, other methods, or a combination thereof. Molding methods include, for example, blow molding, injection molding, compression molding, other molding methods, and combinations thereof.

The multistage polymer of the present invention may provide significant improvements in the flammability of the matrix resin composition.

Some embodiments of the invention will now be described in detail in the following Examples.

### Examples

### Particle Size Measurement

The particle size of the oligomers were measured on a Malvern Zetasizer Nano S90 particle size analyzer.

### Representative Core Shell Polymer Synthesis

### Representative Silicone Core Emulsion Synthesis (S1)

To a 5 liter, 4-necked round bottomed flask equipped with a mechanical stirrer, thermometer, condenser, and electric heating mantel, was charged 2000 g of deionized water and 10 g of dodecyl benzene sulfonic acid. The reactor contents were heated to 85° C. In a separate container, 650 g deionized water, 975 g octamethylcyclotetrasiloxane, 20 g of tetraethoxysilane, and 5 g methacryloxypropyldimethoxymethylsilane, and 4.4 g Sodium dodecyl benzene sulfonate were mixed. The monomer mixture was then added to the kettle over 60 min. When the monomer feed was over, the reaction mixture was stirred at 85° C. for an additional 3 hours. After the hold, the batch was cooled to 40° C. and was held there for 4 hours, before cooled to room temperature. The batch was stirred at room temperature for an additional 18 hours and then neutralized with 45 g of 5% sodium hydroxide aqueous solution. The emulsion was characterized to have a particle size of 170 nm and solids of 23.5%.

### Silicone Core Acrylic Shell Emulsion Polymer Synthesis (Sample 2)

To 2785 parts of the silicone emulsion having 23.5% solids (S1), as prepared above, were added 285 part of deionized water, and the mixture was heated to 60° C. At 60° C. 4.1 part of Rhodafac® RS-610, 3.2 parts of sodium formaldehyde sulfoxylate (5% aqueous solution) and 2.3 parts of tert-butyl hydroperoxide (5% aqueous solution) were added. followed a monomer mixture of 106 parts of methyl methacrylate, 44 parts of styrene, 14.32 parts of PAM600 over 1 hour. At the same time the monomer mixture feed began, 16 parts of sodium formaldehyde sulfoxylate (5% aqueous solution) and 11 parts of tert-butyl hydroperoxide (5% aqueous solution) were fed in over 240 min, while maintaining the reaction temperature at 60° C. After all feeds were completed, 22.4 part of Rhodafac® RS-610 were added. The reaction mixture was then cooled to room temperature and measured to have solid content of 24.3%.

### Representative Procedure of Coagulation (Sample 2)

### Emulsion Preparation

The sample 2 emulsion was neutralized with Sodium phosphate solution to pH 6.9 5297 g of neutralized sample 2 emulsion was agitated and held at 57° C.

### Coagulation

To a 5 gallon vessel was added 16.6 g of solid calcium chloride and 7203.4 g deionized water. The vessels contents were heated to 57° C. under agitation at 500 rpm. When the contents reached 57° C., the preheated emulsion above was added slowly to the vessel. 49.7 gr of calcium chloride dissolved in 200 g of deionized water was added to complete the coagulation. The mixture was then heated to 90° C., and held at 90° C. for 30 minutes. After the hold, the mixture was cooled, dewatered, and washed in a Büchner funnel. The samples were washed with deionized water until the filtrate conductivity is below 30 μS/m, and then dewatered again. After dewatering and washing, the samples were dried in a vacuum oven for 24 hours at 65° C. The particle size of the coagulation slurry was measured on a Malvern Mastersizer 2000.

### Formulation

Polycarbonate formulations in accordance with Table 1 were compounded in an extruder to create pellets for injection molding.

TABLE 1

| Material | Loading level |
|---|---|
| LEXAN 141 | Add to 100% |
| MBS | 2.50% |
| FR-2025a | 0.10% |
| INP449 | 0.50% |
| Irg 1076 | 0.10% |
| Irg 168 | 0.10% |

PC Lexan 141: Polycarbonate from SABIC
MBS: FR MBS powder of Example 1 or M732 powder of Comparative Example
FR-2025a: 100% potassium perfluorobutane sulfonate from 3M
INP449: blend of 50% polytetrafluoroethylene and 50% SAN from SABIC
IRGANOX ® 1076 and IRGANOX ® 168: anti-oxidants from BASF

The polycarbonate formulations were injection molded to form double end-gated 1.0 mm ASTM burn bars for flammability testing using the UL 94 flammability test method.

TABLE 2

| | | | | | Final Latex | |
|---|---|---|---|---|---|---|
| | Composition (wt %) | | | | Solids | Particle |
| Silicone | | | | Phospho- | content | size |
| core | D4 | TEOS | MADS | silane | (wt %) | (nm) |
| S1 | 97.5% | 2.0% | 0.5% | 0.0% | 23.5% | 170 |
| S2 | 95.5% | 2.0% | 0.5% | 2.0% | 22.6% | 165 |
| S3 | 89.5% | 10% | 0.5% | 0% | 22.13% | 171 |

TABLE 3

| | | | | | | Final Latex | |
|---|---|---|---|---|---|---|---|
| | Sili- | | Shell Composition | | | Solids | Particle |
| | cone | Core// | | | PAM | Content | size |
| Sample | core | Shell | MMA | Styrene | 600 | (wt %) | (nm) |
| 1 | S1 | 80//20 | 70.0% | 30.0% | 0.0% | 24.0% | 171 |
| 2 | S1 | 80//20 | 67.0% | 28.0% | 5.0% | 24.3% | Not |
| | | | | | | | measured |
| 3 | S2 | 80//20 | 70.0% | 30.0% | 0.0% | 23.5% | Not |
| | | | | | | | measured |
| 4 | S2 | 80//20 | 67.0% | 28.0% | 5.0% | 23.4% | 134 |

TABLE 4

| | | | | | | Final Latex | |
|---|---|---|---|---|---|---|---|
| | Sili- | | Shell Composition | | | Solids | Particle |
| | cone | Core// | | | PAM | Content | Size |
| Sample | core | Shell | MMA | Styrene | 600 | (wt %) | (nm) |
| 5 | S1 | 80//20 | 70.0% | 30.0% | 0.0% | 24.0% | 172 |
| 6 | S1 | 80//20 | 71.0% | 28.0% | 1.0% | 24.1% | 174 |
| 7 | S1 | 80//20 | 69.5% | 28.0% | 2.5% | 24.0% | 173 |
| 8 | S1 | 80//20 | 67.0% | 28.0% | 5.0% | 24.0% | 169 |
| 9 | S1 | 80//20 | 64.0% | 26.0% | 10.0% | 23.7% | 173 |
| 10 | S3 | 80//20 | 67.0% | 28.0% | 5.0% | 23.9% | 182 |

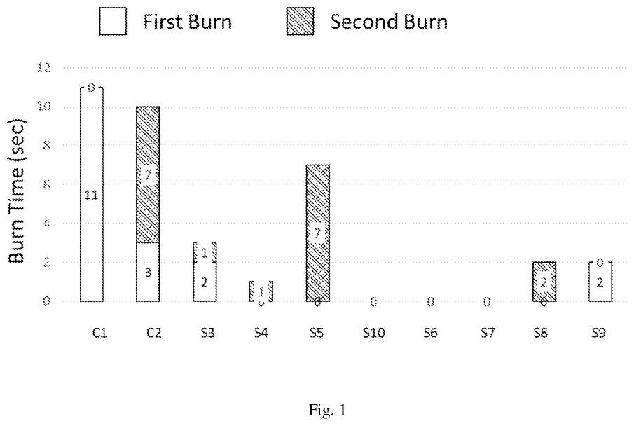

Samples 1-10 were also tested for flame resistance using the UL-94 flammability test. Each of the samples exhibited excellent flame resistance (V-0). As shown in FIG. 1, the inventive samples also exhibited excellent burn times compared to samples containing no phosphorus. Comparative Examples contained a commercially available silicone polymer for the core (C1 had a 70//30 core//shell weight ratio; C2 had a 80//20 core//shell weight ratio) and no phosphorus in the core//shell polymer.

1. A multistage polymer composition comprising:
(a) a core comprising a silicone polymer; and
(b) a shell comprising an acrylic polymer,
wherein at least one of the silicone polymer in the core and the acrylic polymer in the shell comprises polymerized units derived from an organo-phosphorus monomer.

2. The polymer composition of claim 1, wherein the organo-phosphorus monomer comprises a phosphate functional group or a phosphonate functional group.

3. The polymer composition of claim 1, wherein the silicone polymer in the core comprises polymerized units derived from a phospho-silane monomer.

4. The polymer composition of claim 3, wherein the phospho-silane monomer is present in the silicone polymer in an amount ranging from 0.1 to 10 wt % relative to the total weight of the silicone polymer.

5. The polymer composition of claim 3, wherein the phospho-silane monomer is a compound of formula, Si(OR²)₃—R³—P(O)(OR⁴)₂, where R² and R⁴ are independently selected from hydrogen or C₁ to C₁₂ alkyl groups, and R³ is selected from a C₁ to C₁₂ alkyl group.

6. The polymer composition of claim 5, wherein R², R³ and R⁴ are independently selected from C₁ to C₆ alkyl groups.

7. The polymer composition of claim 1, wherein the acrylic polymer in the shell comprises units derived from an organo-phosphorus monomer.

8. The polymer composition of claim 7, wherein the organo-phosphorus monomer is present in the acrylic polymer in an amount ranging from 0.5 to 20 wt % relative to the total weight of the acrylic polymer.

9. The polymer composition of claim 8, wherein the organo-phosphorus monomer is present in the acrylic polymer in an amount ranging from 2 to 10 wt % relative to the total weight of the acrylic polymer.

10. The polymer composition of claim 7, wherein the organo-phosphorus monomer in the acrylic polymer in the shell is a compound of formula, CH₂═C(R⁵)—C(O)—O—(R⁶O)ₙ—P(O)(OH)₂, where R⁵ is H or —CH₃, R⁵=alkyl, and n=1 to 5.

11. The polymer composition of claim 9, wherein R⁵ is —CH₃ and R⁶ is a C₁ to C₆ alkyl group.

12. The polymer composition of claim 1, wherein the silicone polymer is present in an amount of from 2 to 98 weight %, based on the total weight of the multistage polymer, and the acrylic polymer is present in an amount of from 2 to 98 weight %, based on the total weight of the multistage polymer.

13. A matrix resin composition comprising mixing one or more matrix resins and the multistage polymer composition of claim 1.
